(19) United States
(12) Patent Application Publication
(10) Pub. No.: US 2015/0021151 A1
(43) Pub. Date: Jan. 22, 2015

(54) LUMINOUS KEYBOARD

(71) Applicant: PRIMAX ELECTRONICS LTD., TAIPEI (TW)

(72) Inventor: Chung-Yuan Chen, Taipei (TW)

(73) Assignee: PRIMAX ELECTRONICS LTD., TAIPEI (TW)

(21) Appl. No.: 14/050,005

(22) Filed: Oct. 9, 2013

(30) Foreign Application Priority Data
Jul. 19, 2013 (TW) 102125934

(51) Int. Cl. H01H 13/84; H01H 13/83

(52) U.S. Cl. CPC H01H 13/84; H01H 13/83
USPC 200/5 A

(57) ABSTRACT

A luminous keyboard includes a light-emitting element, a proximity sensor, a membrane wiring board, and plural keys. The plural keys are aligned with the plural membrane switches for triggering the plural membrane switches. The light-emitting element is used for providing a light beam to the luminous keyboard. The membrane wiring board has a receiving part for accommodating a signal processing unit of the proximity sensor. In accordance with the present invention, a sensing unit and the signal processing unit of the proximity sensor are used for sensing whether an object is locate near the illuminated keyboard or not. Since the signal processing unit of the proximity sensor is accommodated within the receiving part, it is not necessary to provide an additional accommodation space for accommodating the proximity sensor. Consequently, the luminous keyboard can meet the requirements of slimness and miniaturization.

### FIELD OF THE INVENTION

The present invention relates to a keyboard, and more particularly to a luminous keyboard with an illuminating function.

### BACKGROUND OF THE INVENTION

Recently, with the increasing development of information industries, portable information devices such as notebook computers, mobile phones or personal digital assistants are widely used in many instances. In case that a portable information device is used in a dim environment, the numbers and the characters marked on the keys of the keyboard of the portable information device are not clearly visible. In other words, the dim environment becomes hindrance from operating the keyboard. In addition, if the numbers and the characters marked on the keys of the keyboard are reluctantly viewed in the dim environment, the user is readily suffered from vision impairment. For solving these drawbacks, a luminous keyboard has been introduced into the market. The luminous keyboard can be used in the dim environment in order to enhance the applications thereof. Moreover, by changing the luminous layout of the luminous keyboard, the information device having the luminous keyboard is more aesthetically-pleasing and thus the competiveness thereof is enhanced.

FIG. 1 is a schematic cross-sectional view illustrating a conventional luminous keyboard. FIG. 2 is a schematic perspective view illustrating a membrane wiring board and a keyboard circuit board of the conventional luminous keyboard of FIG. 1. FIG. 3 is a schematic exploded view illustrating the membrane wiring board of the conventional luminous keyboard of FIG. 1. Please refer to FIGS. 1, 2 and 3. The conventional luminous keyboard 1 comprises a reflective plate 11, a light guide plate 12, a metallic supporting plate 13, a membrane wiring board 14, plural keys 15, plural light-emitting elements 16, and a keyboard circuit board 17. The membrane wiring board 14 is electrically connected with the keyboard circuit board 17 through a flat cable 171. The keyboard circuit board 17 is in communication with a computer system (not shown) by a wired transmission technology (e.g. through connecting wire or a USB interface or a PS/2 interface) or a wireless transmission technology (e.g. a Wi-Fi transmission technology). The membrane wiring board 14 comprises a lower wiring plate 141, an upper wiring plate 142, and an intermediate plate 143. The intermediate plate 143 is arranged between the lower wiring plate 141 and the upper wiring plate 142. The lower wiring plate 141, the intermediate plate 143 and the upper wiring plate 142 are all made of a transparent material.

The lower wiring plate 141 comprises a first circuit pattern 1411. The first circuit pattern 1411 comprises plural silver paste conductor lines 14111 and plural lower contacts 14112. The upper wiring plate 142 comprises a second circuit pattern 1421. The second circuit pattern 1421 comprises plural silver paste conductor lines 14211 and plural upper contacts 14212. The intermediate plate 143 comprises plural perforations 1431 corresponding to the plural lower contacts 14112 and the plural upper contacts 14212, respectively. Each of the upper contacts 14212 and the corresponding lower contact 14112 are collectively defined as a membrane switch 144.

The metallic supporting plate 13 is disposed under the membrane wiring board 14 for connecting the plural keys 15. In addition, the metallic supporting plate 13 comprises plural supporting plate openings 131 corresponding to the plural keys 15. Each of the keys 15 is disposed over a corresponding membrane switch 144. As any key 15 is depressed and moved downwardly, the corresponding membrane switch 144 is pushed by the key 15, and thus the corresponding membrane switch 144 is electrically conducted. Under this circumstance, the luminous keyboard 1 generates a corresponding key signal to the keyboard circuit board 17. By the electronic components (not shown) of the keyboard circuit board 17, the key signal is converted into a digital signal that is readable by the computer system.

Moreover, the light-emitting elements 16 are located at bilateral sides of the light guide plate 12 for emitting light beams into the light guide plate 12. The light guide plate 12 is disposed on the reflective plate 11. Moreover, plural light-guiding dots 121 are formed on a bottom surface of the light guide plate 12 for collecting and scattering the light beams. The light-guiding dots 121 are aligned with corresponding keys 15. After the light beams are introduced into the light guide plate 12, the light beams are diffused within the whole light guide plate 12. Due to the ink properties of the light-guiding dots 121, the light beams will be scattered upwardly and downwardly. The portions of the light beams that are scattered upwardly will be sequentially transmitted through the plural supporting plate openings 131 of the metallic supporting plate 13 and the membrane wiring board 14 and then projected to the plural keys 15. The portions of the light beams that are scattered downwardly will be reflected by the reflective plate 11, and the reflected light beams are directed upwardly. Consequently, the light beams provided by the light-emitting elements 16 can be well utilized. Under this circumstance, the purpose of illuminating the plural keys 15 is achieved.

Generally, after the conventional luminous keyboard 1 is manually turned on by the user, the light-emitting elements 16 are driven to emit the light beams. Moreover, after the conventional luminous keyboard 1 is manually turned off by the user, the light-emitting elements 16 stop emitting the light beams. As known, the way of manually controlling the illuminating function is not user-friendly. Moreover, the illuminating function of the luminous keyboard 1 is usually enabled by the user in the dim environment. However, when the user leaves the luminous keyboard 1, the user often forgets disabling the illuminating function of the luminous keyboard 1. Consequently, even if the luminous keyboard 1 is not used by any user, the light-emitting elements 16 still emit the light beams. In other words, the use of the conventional luminous keyboard 1 has the problem of wasting electric energy.

For solving the above drawbacks, a luminous keyboard with a proximity sensor is disclosed in Chinese utility model patent Nos. CN201440241. When a user near the luminous keyboard is sensed by the proximity sensor, the light-emitting element is automatically driven to provide a light beam. When the proximity sensor senses that the user leaves the luminous keyboard, the light-emitting element stops emitting the light beam automatically. Consequently, the drawbacks caused by the manual control will be avoided. However, since a signal processing unit of the proximity sensor is disposed within a casing of the luminous keyboard and located near the membrane wiring board, the casing of the luminous keyboard should be large enough to accommodate the signal processing unit of the proximity sensor. Under this circumstance, the luminous keyboard fails to meet the requirements of light weightiness, slimness and miniaturization.

Therefore, there is a need of providing an improved luminous keyboard in order to eliminate the above drawbacks.

### SUMMARY OF THE INVENTION

The present invention relates to a luminous keyboard, and more particularly to a luminous keyboard with a proximity sensor.

In accordance with an aspect of the present invention, there is provided a luminous keyboard. The luminous keyboard includes at least one light-emitting element, a proximity sensor, a membrane wiring board, and plural keys. The at least one light-emitting element is used for providing a light beam to the luminous keyboard. The proximity sensor includes a sensing unit and a signal processing unit connected with the sensing unit. When the sensing unit senses that an object enters a sensing range, the signal processing unit issues a sensing signal. In response to the sensing signal, an operating mode of the luminous keyboard is switched. The membrane wiring board includes plural membrane switches. The plural keys are used for correspondingly triggering the plural membrane switches. The membrane wiring board includes at least one receiving part for accommodating the signal processing unit.

In accordance with another aspect of the present invention, there is provided a luminous keyboard. The luminous keyboard includes at least one light-emitting element, a proximity sensor, a membrane wiring board, and plural keys. The at least one light-emitting element is used for providing a light beam to the luminous keyboard. The proximity sensor includes a sensing unit and a signal processing unit connected with the sensing unit. When the sensing unit senses that an object enters a sensing range, the signal processing unit issues a sensing signal. In response to the sensing signal, an operating mode of the luminous keyboard is switched. The membrane wiring board includes plural membrane switch regions and a non-membrane switch region separated from the plural membrane switch regions. The plural membrane switches are located at the plural membrane switch regions, respectively. The plural keys are used for correspondingly triggering the plural membrane switches. The membrane wiring board includes at least one receiving part for accommodating the signal processing unit. In addition, the sensing unit is disposed on the non-membrane switch region.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a conventional luminous keyboard;

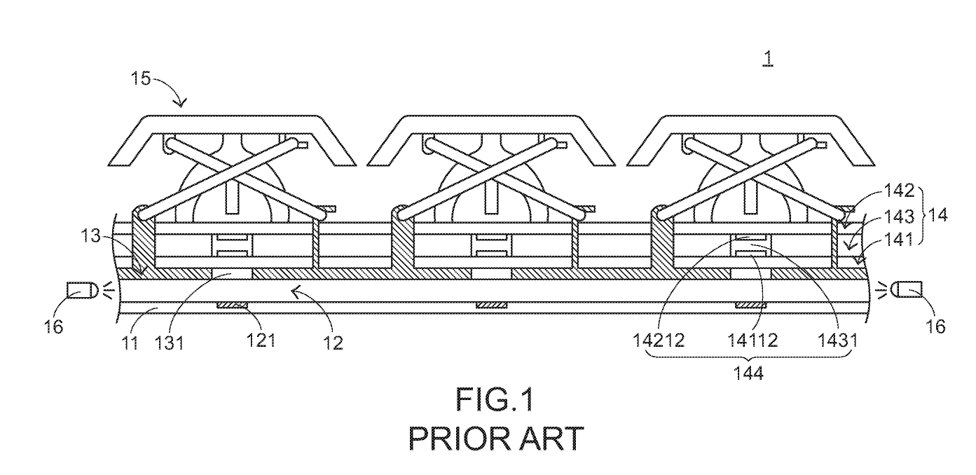

FIG. 2 is a schematic perspective view illustrating a membrane wiring board and a keyboard circuit board of the conventional luminous keyboard of FIG. 1;

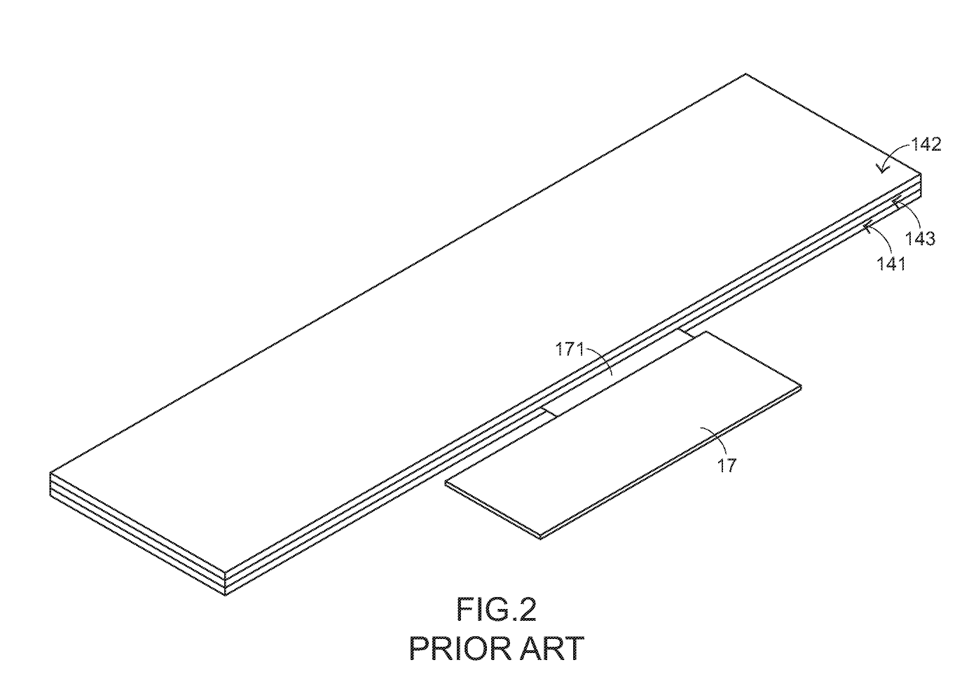

FIG. 3 is a schematic exploded view illustrating the membrane wiring board of the conventional luminous keyboard of FIG. 1;

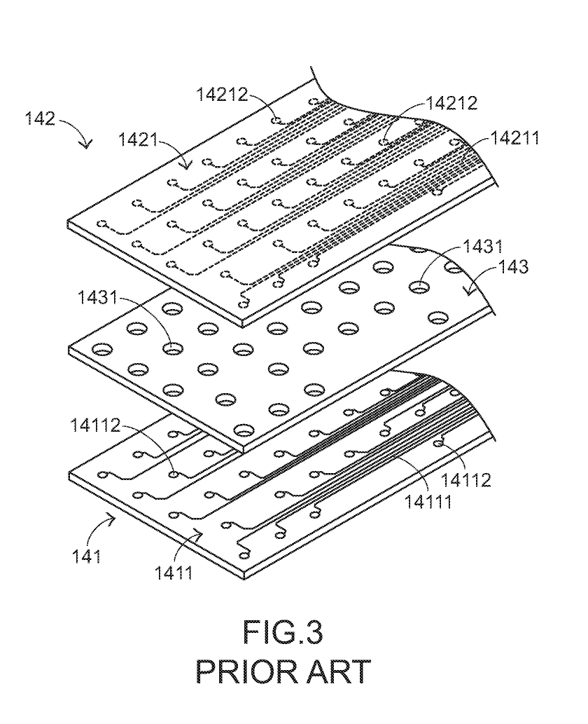

FIG. 4 is a schematic side view illustrating a luminous keyboard according to a first embodiment of the present invention;

FIG. 5 is a schematic perspective view illustrating a membrane wiring board and a keyboard circuit board of the luminous keyboard of FIG. 4;

FIG. 6 is a schematic exploded view illustrating the membrane wiring board of the luminous keyboard of FIG. 4;

FIG. 7 is a schematic exploded view illustrating an upper wiring plate of the membrane wiring board and a metallic supporting plate of the luminous keyboard of FIG. 4;

FIG. 8 is a schematic side view illustrating a luminous keyboard according to a second embodiment of the present invention;

FIG. 9 is a schematic side view illustrating a luminous keyboard according to a third embodiment of the present invention; and

FIG. 10 is a schematic side view illustrating a luminous keyboard according to a fourth embodiment of the present invention.

### DETAILED DESCRIPTION OF THE PREFERRED EMBODIMENT

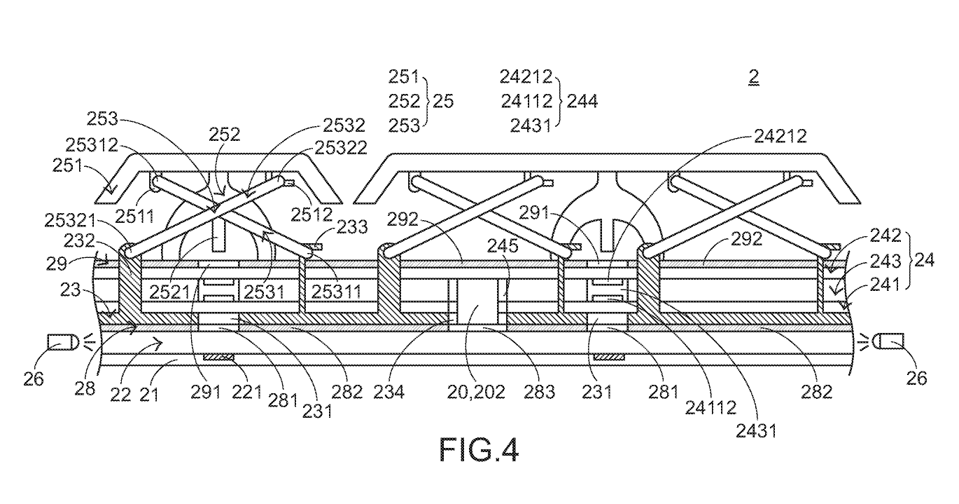

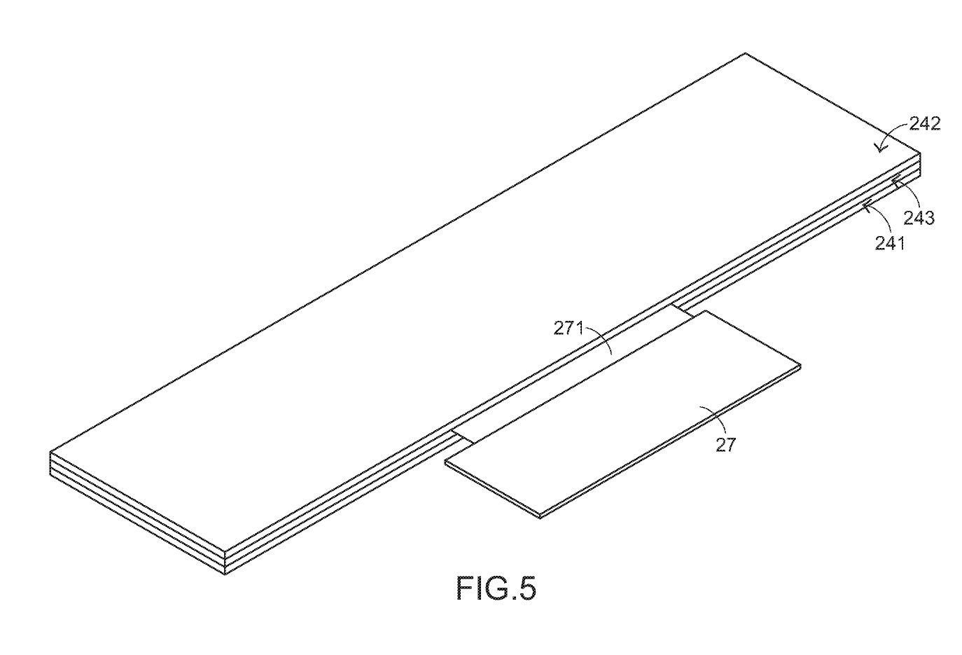

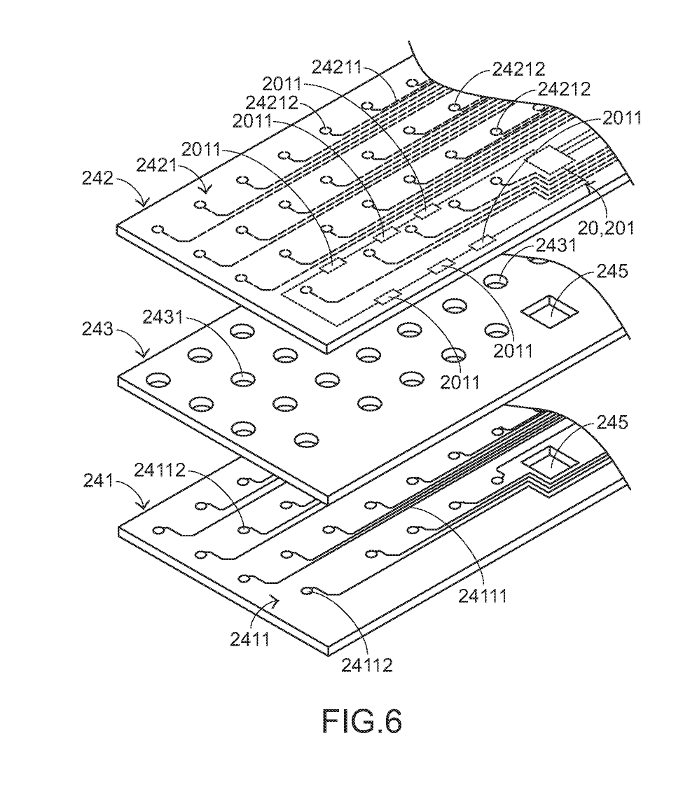

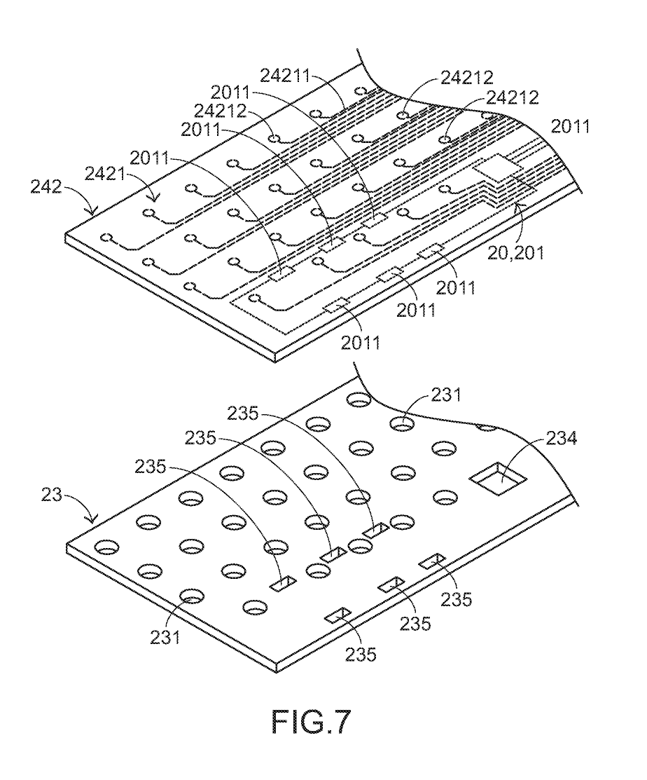

Please refer to FIGS. 4-7. FIG. 4 is a schematic side view illustrating a luminous keyboard according to a first embodiment of the present invention. FIG. 5 is a schematic perspective view illustrating a membrane wiring board and a keyboard circuit board of the luminous keyboard of FIG. 4. FIG. 6 is a schematic exploded view illustrating the membrane wiring board of the luminous keyboard of FIG. 4. FIG. 7 is a schematic exploded view illustrating an upper wiring plate of the membrane wiring board and a metallic supporting plate of the luminous keyboard of FIG. 4.

From bottom to top, a reflective plate 21, a light guide plate 22, a light-shading layer 28, a metallic supporting plate 23, a membrane wiring board 24, a fixing layer 29 and plural keys 25 of the luminous keyboard 2 are sequentially shown. The luminous keyboard 2 further comprises plural light-emitting elements 26, a proximity sensor, and a keyboard circuit board 27. The light-emitting elements 26 are located at bilateral sides of the light guide plate 22. The proximity sensor is arranged between the reflective plate 21 and the fixing layer 29. The keyboard circuit board 27 is electrically connected with the membrane wiring board 24. The keyboard circuit board 27 is in communication with a computer system (not shown) by a wired transmission technology (e.g. through connecting wire or a USB interface or a PS/2 interface) or a wireless transmission technology (e.g. a Wi-Fi transmission technology). In this embodiment, the light-emitting elements 26 are located at bilateral sides of the light guide plate 22. It is noted that the positions of the light-emitting elements 26 are not restricted. For example, in some other embodiments, the light-emitting elements 26 are embedded into appropriate positions of the light guide plate 22.

The membrane wiring board 24 comprises a lower wiring plate 241 and an upper wiring plate 242. A first circuit pattern 2411 is formed on a top surface of the lower wiring plate 241. The first circuit pattern 2411 comprises plural silver paste conductor lines 24111 and plural lower contacts 24112. A second circuit pattern 2421 is formed on a bottom surface of the upper wiring plate 242. The second circuit pattern 2421 comprises plural silver paste conductor lines 24211 and plural upper contacts 24212. The plural upper contacts 24212 are aligned with the plural lower contacts 24112, respectively. Each of the upper contacts 24212 and the corresponding lower contact 24112 are separated from each other by a spacing distance. Moreover, each of the upper contacts 24212 and the corresponding lower contact 24112 are collectively defined as a membrane switch 244. For allowing each of the upper contacts 24212 and the corresponding lower contact 24112 to be separated from each other by the spacing distance, the membrane wiring board 24 further comprises an intermediate plate 243. The intermediate plate 243 is arranged between the lower wiring plate 241 and the upper wiring plate 242. The intermediate plate 243 comprises plural perforations 2431 corresponding to the plural lower contacts 24112 and the plural upper contacts 24212, respectively.

The metallic supporting plate 23 is used for connecting the plural keys 25. In addition, the metallic supporting plate 23 comprises plural supporting plate openings 231 corresponding to the plural keys 25. The plural keys 25 are aligned with corresponding membrane switches 244. Each key 25 comprises a keycap 251 and a connecting element 253. The connecting element 253 is arranged between the metallic supporting plate 23 and the corresponding keycap 251 for connecting the metallic supporting plate 23 and the corresponding keycap 251. Moreover, due to the connecting element 253, the keycap 251 is movable upwardly or downwardly relative to the metallic supporting plate 23.

In this embodiment, the connecting element 253 is a scissors-type connecting element. Moreover, the scissors-type connecting element 253 comprises a first frame 2531 and a second frame 2532. The metallic supporting plate 23 further comprises a first fixing structure 232 and a second fixing structure 233. Each of the plural keys 25 further comprises an elastic element 252. The elastic element 252 is fixed on the fixing layer 29, and arranged between the corresponding keycap 251 and the fixing layer 29. Moreover, the elastic element 252 has a sustaining part 2521. The keycap 251 of each key 25 comprises a first keycap connecting structure 2511 and a second keycap connecting structure 2512.

A first end 25311 of the first frame 2531 is connected to the second fixing structure 233, and a second end 25312 of the first frame 2531 is connected to the first keycap connecting structure 2511. In addition, a first end 25321 of the second frame 2532 is connected to the first fixing structure 232, and a second end 25322 of the second frame 2532 is connected to the second keycap connecting structure 2512. It is noted that the connection relationships between the connecting element 253, the metallic supporting plate 23 and the keycap 251 are presented herein for purpose of illustration and description only.

Moreover, as any key 25 is depressed and moved downwardly relative to the membrane wiring board 24, the first frame 2531 and the second frame 2532 of the corresponding connecting element 253 are switched from an open-scissors state to a folded state. Moreover, in response to the downward movement of the keycap 251, the corresponding elastic element 252 is compressed by the keycap 251, and the corresponding upper contact 24212 is pushed by the sustaining part 2521 of the elastic element 252. Consequently, the corresponding upper contact 24212 is contacted with the corresponding lower contact 24112 through the corresponding perforation 2431, and the corresponding membrane switch 244 is electrically conducted. Under this circumstance, the membrane wiring board 24 generates a corresponding key signal to the keyboard circuit board 27. By the keyboard circuit board 27, the key signal is converted into a digital signal that is readable by the computer system. Then, the key signal is transmitted from the keyboard circuit board 27 to the computer system. Moreover, when the depressing force exerted on the key 25 is eliminated, the keycap 251 is moved upwardly relative to the membrane wiring board 24 in response to the elastic force of the elastic element 252. Under this circumstance, the first frame 2531 and the second frame 2532 are switched from the folded state to the open-scissors state, and the keycap 251 is returned to its original position.

Moreover, in this embodiment, the light-emitting element 26 is a light emitting diode. Moreover, the light guide plate 22 is made of polyethylene terephthalate (PET), polycarbonate (PC), thermoplastic polyurethane (TPU) or polymethylmethacrylate (PMMA), but is not limited thereto. The light-emitting element 26 is used for emitting a light beam into the light guide plate 22. Moreover, the light guide plate 22 has plural light-guiding dots 221 for collecting and scattering the light beam. The light-guiding dots 221 are aligned with corresponding keys 25, respectively. After the light beam is introduced into the light guide plate 22, the light beam is diffused within the whole light guide plate 22. Due to the properties (e.g. the ink properties) or the structures (e.g. microstructures) of the plural light-guiding dots 221, the light beam will be scattered upwardly and downwardly.

In this embodiment, the light-shading layer 28 comprises plural light-transmissible regions 281 and a light-shading region 282. The plural light-transmissible regions 281 are aligned with the plural keys 25, respectively. The light-shading region 282 is arranged around the plural light-transmissible regions 281. Similarly, the fixing layer 29 comprises plural light-transmissible regions 291 and a light-shading region 292. The plural light-transmissible regions 291 are aligned with the plural keys 25, respectively. The light-shading region 292 is arranged around the plural light-transmissible regions 291. The lower wiring plate 241, the intermediate plate 243 and the upper wiring plate 242 of the membrane wiring board 24 are all made of a transparent material. The portion of the light beam that is scattered upwardly by the plural light-guiding dots 221 will be sequentially transmitted through the light-transmissible regions 281 of the light-shading layer 28, the plural supporting plate openings 231 of the metallic supporting plate 23, the membrane wiring board 24 and the light-transmissible regions 291 of the fixing layer 29, and directed to the plural keys 25. In addition, the light beam is outputted from light-outputting regions (not shown) of the keycaps 251. For example, the light-outputting regions of the keycaps 251 are symbol regions, number regions or character regions. Consequently, the luminous keyboard 2 can be operated by the user in a dim environment.

Moreover, the portion of the light beam that is scattered downwardly by the plural light-guiding dots 221 is projected to the reflective plate 21 and reflected by the reflective plate 21. The reflected light beam is introduced into the light guide plate 22 again. Since the portion of the light beam that is provided by the light-emitting element 26 and scattered downwardly by the plural light-guiding dots 221 is not lost, the light beam can be well utilized. Under this circumstance, the light utilization efficiency of the luminous keyboard 2 is enhanced.

The proximity sensor comprises a sensing unit and a signal processing unit. In this embodiment, the proximity sensor is a capacitive proximity sensor 20, the sensing unit is a sensing antenna circuit 201, and the signal processing unit is a signal processing chip 202. In addition, the signal processing chip 202 is electrically connected with the keyboard circuit board 27. Moreover, plural sensing regions 2011 are distributed on the sensing antenna circuit 201. When an electric current flows through the sensing antenna circuit 201, the sensing antenna circuit 201 generates a sensing electric field. Meanwhile, if an object enters a sensing range of the sensing antenna circuit 201, the sensing electric field is subject to a change. Due to the change of the sensing electric field, the signal processing chip 202 issues a sensing signal to the keyboard circuit board 27. In response to the sensing signal, the keyboard circuit board 27 will drive the luminous keyboard 2 to switch the operating mode.

After the sensing signal is received by the keyboard circuit board 27, the keyboard circuit board 27 judges that the object (e.g. a human body) is located near the luminous keyboard 2, and thus the light-emitting element 26 is driven to emit the light beam. Under this circumstance, the illuminating function of the luminous keyboard 2 is enabled. On the other hand, when the human body is far away from the luminous keyboard 2 (i.e. the object is far away from the sensing range), the sensing electric field is also subject to a change. Due to the change of the sensing electric field, the signal processing chip 202 issues another sensing signal to the keyboard circuit board 27. Consequently, the keyboard circuit board 27 stops driving the light-emitting element 26. Under this circumstance, the illuminating function of the luminous keyboard 2 is disabled. In other words, by judging whether the user is located near the illuminated keyboard 2 or not, the illuminating function of the luminous keyboard 2 is automatically enabled or disabled.

The above method of converting the operating mode of the luminous keyboard 2 according to the sensing result of the proximity sensor is presented herein for purpose of illustration and description only. However, those skilled in the art will readily observe that numerous modifications and alterations may be made according to the practical requirements. For example, in some embodiments, other functions of the luminous keyboard 2 may be enabled or disabled according to the sensing result of the proximity sensor.

The spirits of the present invention will be illustrated as follows. The signal processing chip 202 has a specified thickness. Consequently, in this embodiment, the membrane wiring board 24 has a receiving part 245, which runs through the intermediate plate 243 and the lower wiring plate 241. Moreover, the metallic supporting plate 23 has a supporting plate opening 234, and the light-shading layer 28 has a light-shading layer opening 283. The supporting plate opening 234 and the light-shading layer opening 283 are in communication with the receiving part 245 of the membrane wiring board 24. Consequently, the signal processing chip 202 can be accommodated within the receiving part 245 of the membrane wiring board 24, the supporting plate opening 234 and the light-shading layer opening 283.

In this embodiment, the sensing antenna circuit 201 is disposed on the bottom surface of the upper wiring plate 242. Moreover, the signal processing chip 202 is also disposed on the bottom surface of the upper wiring plate 242. In a preferred embodiment, for providing better sensing efficacy of the sensing antenna circuit 201, the metallic supporting plate 23 further comprises plural supporting plate apertures 235 corresponding to the plural sensing regions 2011. Due to the plural supporting plate apertures 235, the influence of the shielding effect of the metallic material on the sensing antenna circuit 201 will be avoided. Moreover, in this embodiment, the membrane wiring board 24 and the signal processing chip 202 are connected with the keyboard circuit board 27 through a single flat cable 271, but are not limited thereto.

From the above discussions about the luminous keyboard 2 of the first embodiment, the capacitive proximity sensor 20 is buried within the fixing layer 29, the membrane wiring board 24, the metallic supporting plate 23 and the light-shading layer 28. In other words, it is not necessary to provide an additional accommodation space for the luminous keyboard 2 to accommodate the capacitive proximity sensor 20. Consequently, the luminous keyboard 2 can meet the requirements of light weightiness, slimness and miniaturization.

The above assembled structures of the luminous keyboard 2 are presented herein for purpose of illustration and description only. However, those skilled in the art will readily observe that numerous modifications and alterations may be made according to the practical requirements. For example, in some other embodiments, the sensing antenna circuit 201 may be disposed on a top surface of the fixing layer 29, a bottom surface of the fixing layer 29, a top surface of the upper wiring plate 242, a top surface of the intermediate plate 243, a bottom surface of the intermediate plate 243, a top surface of the lower wiring plate 241 or a bottom surface of the lower wiring plate 241. In addition, the signal processing chip 202 is disposed on the bottom surface of the fixing layer 29, the top surface of the upper wiring plate 242, the top surface of the intermediate plate 243, the bottom surface of the intermediate plate 243, the top surface of the lower wiring plate 241 or the bottom surface of the lower wiring plate 241. It is noted that the sensing antenna circuit 201 and the signal processing chip 202 may be disposed on the same surface or different surfaces. That is, the sensing antenna circuit 201 and the signal processing chip 202 may be electrically connected with each other by vertical connection. For example, the sensing antenna circuit 201 and the signal processing chip 202 may be electrically connected with each other by means of vertical conducting wires or electrical contacts, which run through at least one of the fixing layer 29, the upper wiring plate 242, the intermediate plate 243 and the lower wiring plate 241.

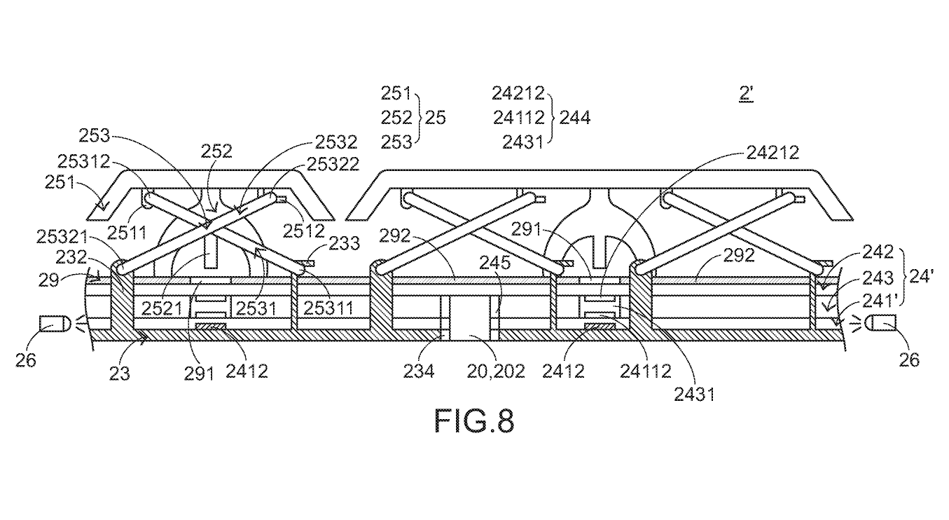

FIG. 8 is a schematic side view illustrating a luminous keyboard according to a second embodiment of the present invention. Except for the following items, the assembled structures of the luminous keyboard 2′ of this embodiment are substantially identical to those of the luminous keyboard 2 of the first embodiment, and are not redundantly described herein. In comparison with the luminous keyboard 2 of the first embodiment, the luminous keyboard 2′ of this embodiment does not have the reflective plate 21 and the light guide plate 22. Whereas, the lower wiring plate 241′ is directly made of a light-guiding material. An example of the light-guiding material includes but is not limited to polyethylene terephthalate (PET), polycarbonate (PC), thermoplastic polyurethane (TPU) or polymethylmethacrylate (PMMA). Moreover, the lower wiring plate 241′ has plural light-guiding dots 2412 for collecting and scattering the light beam. The light-emitting element 26 is located at a lateral side of the lower wiring plate 241′. Consequently, the lower wiring plate 241′ of the membrane wiring board 24 has a light-guiding function. In comparison with the luminous keyboard 2, the thickness of the luminous keyboard 2′ is smaller. The position of the proximity sensor 20 and the operating principles of the proximity sensor 20 are similar to those of the first embodiment, and are not redundantly described herein. Of course, numerous modifications and alterations of the luminous keyboard 2 of the first embodiment may be applied to the luminous keyboard 2′ of this embodiment.

The above assembled structures of the luminous keyboard 2′ are presented herein for purpose of illustration and description only. However, those skilled in the art will readily observe that numerous modifications and alterations may be made according to the practical requirements. For example, in some embodiments, the intermediate plate is directly made of a light-guiding material, and the intermediate plate has plural light-guiding dots for collecting and scattering the light beam. Alternatively, in some embodiments, the upper wiring plate is directly made of a light-guiding material, and the upper wiring plate has plural light-guiding dots for collecting and scattering the light beam.

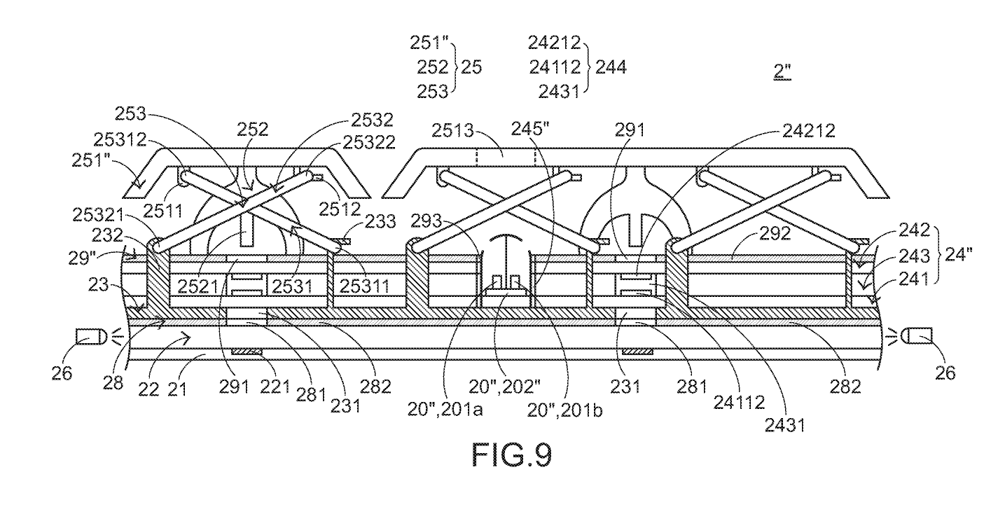

FIG. 9 is a schematic side view illustrating a luminous keyboard according to a third embodiment of the present invention. Except for the following items, the assembled structures of the luminous keyboard 2″ of this embodiment are substantially identical to those of the luminous keyboard 2 of the first embodiment, and are not redundantly described herein. In comparison with the luminous keyboard 2 of the first embodiment, the proximity sensor of the luminous keyboard 2″ of this embodiment is an optical proximity sensor 20″. Moreover, the sensing unit comprises an infrared ray emitting unit 201a and an infrared ray receiving unit 201b, and the signal processing unit is a signal processing chip 202″. The optical proximity sensor 20″ is electrically connected between the keyboard circuit board 27, the infrared ray emitting unit 201a and the infrared ray receiving unit 201b. Moreover, one specified keycap 251″ corresponding to the infrared ray emitting unit 201a has an infrared ray outputting region 2513. The infrared ray emitted by the infrared ray emitting unit 201a is outputted to the surroundings through the infrared ray outputting region 2513. If an object enters a sensing range of the optical proximity sensor 20″ and the infrared ray emitted by the infrared ray emitting unit 201a is projected on the object, the infrared ray is reflected by the object. Under this circumstance, the propagating direction of the infrared ray is changed. That is, the reflected infrared ray is transmitted through the infrared ray outputting region 2513, and then received by the infrared ray receiving unit 201b. Meanwhile, the signal processing chip 202″ issues a sensing signal to the keyboard circuit board 27. In response to the sensing signal, the keyboard circuit board 27 will drive the luminous keyboard 2″ to switch the operating mode.

After the sensing signal is received by the keyboard circuit board 27, the keyboard circuit board 27 judges that an object (e.g. a human body) is located near the luminous keyboard 2″, and thus the light-emitting element 26 is driven to emit the light beam. Under this circumstance, the illuminating function of the luminous keyboard 2″ is enabled. On the other hand, when the human body is far away from the luminous keyboard 2″ (i.e. the reflected infrared ray is not received by the infrared ray receiving unit 201b), the signal processing chip 202″ issues another sensing signal to the keyboard circuit board 27. Consequently, the keyboard circuit board 27 stops driving the light-emitting element 26. Under this circumstance, the illuminating function of the luminous keyboard 2″ is disabled. In other words, by judging whether the user is located near the illuminated keyboard 2″ or not, the illuminating function of the luminous keyboard 2″ is automatically enabled or disabled.

The above method of converting the operating mode of the luminous keyboard 2″ according to the sensing result of the proximity sensor is presented herein for purpose of illustration and description only. However, those skilled in the art will readily observe that numerous modifications and alterations may be made according to the practical requirements. For example, in some embodiments, other functions of the luminous keyboard 2″ may be enabled or disabled according to the sensing result of the proximity sensor.

Moreover, in this embodiment, the signal processing chip 202″ is disposed on the top surface of the lower wiring plate 241, and the infrared ray emitting unit 201a and the infrared ray receiving unit 201b are disposed on the signal processing chip 202″. The optical proximity sensor 20″ has a specified thickness. Consequently, in this embodiment, the membrane wiring board 24″ has a receiving part 245″, which runs through the upper wiring plate 242 and the intermediate plate 243. Moreover, the fixing layer 29′ has a fixing layer opening 293. The fixing layer opening 293 is in communication with the receiving part 245″ of the membrane wiring board 24″. Consequently, the optical proximity sensor 20″ can be accommodated within the receiving part 245″ of the membrane wiring board 24″ and the fixing layer opening 293 of the fixing layer 29′.

From the above discussions, it is not necessary to provide an additional accommodation space for the luminous keyboard 2″ to accommodate the proximity sensor. Consequently, the luminous keyboard 2″ can meet the requirements of light weightiness, slimness and miniaturization.

The above assembled structures of the luminous keyboard 2″ are presented herein for purpose of illustration and description only. However, those skilled in the art will readily observe that numerous modifications and alterations may be made according to the practical requirements. For example, in some other embodiments, the optical proximity sensor 20″ may be disposed on the top surface of the intermediate plate 243 or the top surface of the upper wiring plate 242.

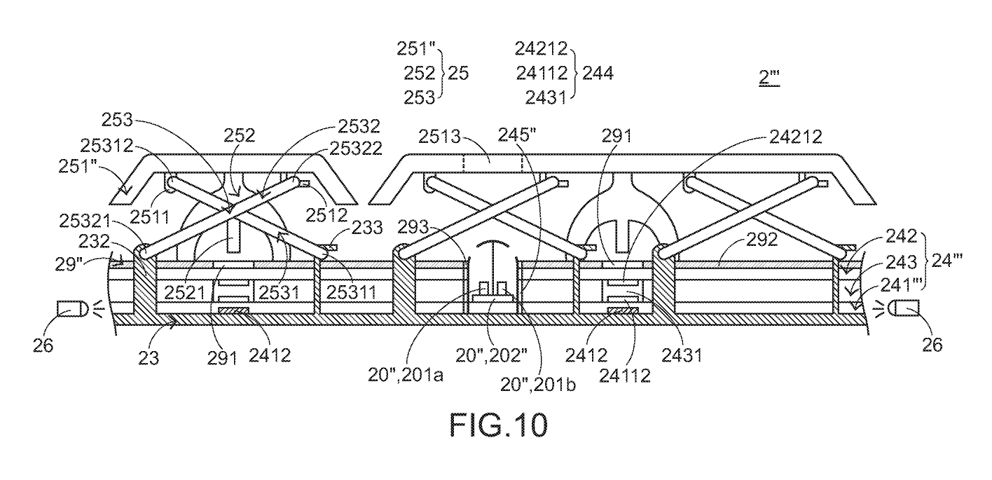

FIG. 10 is a schematic side view illustrating a luminous keyboard according to a fourth embodiment of the present invention. Except for the following items, the assembled structures of the luminous keyboard 2′″ of this embodiment are substantially identical to those of the luminous keyboard 2″ of the third embodiment, and are not redundantly described herein. In comparison with the luminous keyboard 2″ of the third embodiment, the luminous keyboard 2′″ of this embodiment does not have the reflective plate 21 and the light guide plate 22. Whereas, the lower wiring plate 241′″ is directly made of a light-guiding material. An example of the light-guiding material includes but is not limited to polyethylene terephthalate (PET), polycarbonate (PC), thermoplastic polyurethane (TPU) or polymethylmethacrylate (PMMA). Moreover, the lower wiring plate 241′″ has plural light-guiding dots 2412 for collecting and scattering the light beam. The light-emitting element 26 is located at a lateral side of the lower wiring plate 241′″. Consequently, the lower wiring plate 241′″ of the membrane wiring board 24′″ has a light-guiding function. In comparison with the luminous keyboard 2″, the thickness of the luminous keyboard 2′″ is smaller. The position of the optical proximity sensor 20″ and the operating principles of the proximity sensor 20 are similar to those of the third embodiment, and are not redundantly described herein. Of course, numerous modifications and alterations of the luminous keyboard 2″ of the third embodiment may be applied to the luminous keyboard 2′″ of this embodiment. The above assembled structures of the luminous keyboard 2′″ are presented herein for purpose of illustration and description only. However, those skilled in the art will readily observe that numerous modifications and alterations may be made according to the practical requirements. For example, in some embodiments, the intermediate plate is directly made of a light-guiding material, and the intermediate plate has plural light-guiding dots for collecting and scattering the light beam. Alternatively, in some embodiments, the upper wiring plate is directly made of a light-guiding material, and the upper wiring plate has plural light-guiding dots for collecting and scattering the light beam.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A luminous keyboard, comprising:
at least one light-emitting element for providing a light beam to the luminous keyboard;
a proximity sensor comprising a sensing unit and a signal processing unit connected with the sensing unit, wherein when the sensing unit senses that an object enters a sensing range, the signal processing unit issues a sensing signal, wherein in response to the sensing signal, an operating mode of the luminous keyboard is switched;
a membrane wiring board comprising plural membrane switches; and
plural keys for correspondingly triggering the plural membrane switches,
wherein the membrane wiring board comprises at least one receiving part for accommodating the signal processing unit.

2. The luminous keyboard according to claim 1, wherein when the signal processing unit issues the sensing signal, the at least one light-emitting element provides the light beam to the luminous keyboard.

3. The luminous keyboard according to claim 1, wherein the proximity sensor is a capacitive proximity sensor, and the sensing unit is a sensing antenna circuit.

4. The luminous keyboard according to claim 3, wherein the membrane wiring board comprises:
a lower wiring plate having a first circuit pattern, wherein the first circuit pattern comprises plural lower contacts; and
an upper wiring plate having a second circuit pattern, wherein the second circuit pattern comprises plural upper contacts corresponding to the plural lower contacts, wherein each of the upper contacts and the corresponding lower contact are separated from each other by a spacing distance, and each of the upper contacts and the corresponding lower contact are collaboratively defined as the corresponding membrane switch,
wherein the sensing antenna circuit is arranged between the upper wiring plate and the lower wiring plate, or the sensing antenna circuit is disposed on a top surface of the lower wiring plate or a bottom surface of the upper wiring plate.

5. The luminous keyboard according to claim 4, wherein the membrane wiring board further comprises an intermediate plate, wherein the intermediate plate is arranged between the upper wiring plate and the lower wiring plate, so that each of the upper contacts and the corresponding lower contact are separated from each other by the spacing distance, wherein the intermediate plate comprises plural perforations corresponding to the plural upper contacts and the plural upper contacts, respectively, wherein the sensing antenna circuit is disposed on the top surface of the lower wiring plate, a bottom surface of the lower wiring plate, a top surface of the intermediate plate, a bottom surface of the intermediate plate, a top surface of the upper wiring plate or the bottom surface of the upper wiring plate.

6. The luminous keyboard according to claim 5, wherein at least one of the lower wiring plate, the intermediate plate and the upper wiring plate is made of a light-guiding material.

7. The luminous keyboard according to claim 3, further comprising a fixing layer, wherein the fixing layer comprises a light-shading region and at least one light-transmissible region, wherein the at least one light-transmissible region is aligned with at least one key of the plural keys, wherein the sensing antenna circuit is disposed on a top surface of the fixing layer or a bottom surface of the fixing layer.

8. The luminous keyboard according to claim 3, further comprising a metallic supporting plate for connecting the plural keys, wherein the sensing antenna circuit comprises at least one sensing region, and the metallic supporting plate comprises at least one supporting plate aperture corresponding to the at least one sensing region.

9. The luminous keyboard according to claim 8, wherein each of the plural keys comprises:
a keycap exposed outside the luminous keyboard; and
a connecting element arranged between the metallic supporting plate and the keycap for connecting the metallic supporting plate and the keycap, and allowing the keycap to be moved upwardly or downwardly relative to the metallic supporting plate.

10. The luminous keyboard according to claim 9, wherein each of the plural keys comprises an elastic element, the elastic element is arranged between the keycap and the metallic supporting plate, and the elastic element has a sustaining part, wherein the connecting element is a scissors-type connecting element, wherein when the keycap is depressed, the elastic element is compressed, so that the corresponding membrane switch is pushed by the sustaining part, wherein when the keycap is not depressed, the keycap is returned to an original position in response to an elastic force provided by the elastic element.

11. The luminous keyboard according to claim 1, wherein the proximity sensor is an optical proximity sensor, wherein a specified key of the plural keys corresponding to the sensing unit has a sensing ray outputting region.

12. The luminous keyboard according to claim 11, wherein the membrane wiring board comprises:
a lower wiring plate having a first circuit pattern, wherein the first circuit pattern comprises plural lower contacts; and
an upper wiring plate having a second circuit pattern, wherein the second circuit pattern comprises plural upper contacts corresponding to the plural lower contacts, wherein each of the upper contacts and the corresponding lower contact are separated from each other by a spacing distance, and each of the upper contacts and the corresponding lower contact are collaboratively defined as the corresponding membrane switch,
wherein the optical proximity sensor is disposed on a top surface of the lower wiring plate.

13. The luminous keyboard according to claim 12, wherein at least one of the lower wiring plate and the upper wiring plate is made of a light-guiding material.

14. The luminous keyboard according to claim 1, further comprising a keyboard circuit board, wherein the keyboard circuit board is in communication with a computer system, wherein the keyboard circuit board is connected with the membrane wiring board and the proximity sensor through a single flat cable.

15. A luminous keyboard, comprising:
at least one light-emitting element for providing a light beam to the luminous keyboard;
a proximity sensor comprising a sensing unit and a signal processing unit connected with the sensing unit, wherein when the sensing unit senses that an object enters a sensing range, the signal processing unit issues a sensing signal, wherein in response to the sensing signal, an operating mode of the luminous keyboard is switched;
a membrane wiring board comprising plural membrane switch regions and a non-membrane switch region separated from the plural membrane switch regions, wherein plural membrane switches are located at the plural membrane switch regions, respectively; and
plural keys for correspondingly triggering the plural membrane switches,
wherein the membrane wiring board comprises at least one receiving part for accommodating the signal processing unit, and the sensing unit is disposed on the non-membrane switch region.

16. The luminous keyboard according to claim 15, wherein when the signal processing unit issues the sensing signal, the at least one light-emitting element provides the light beam to the luminous keyboard.

17. The luminous keyboard according to claim 15, wherein the proximity sensor is a capacitive proximity sensor, and the sensing unit is a sensing antenna circuit.

18. The luminous keyboard according to claim 17, wherein the membrane wiring board comprises:
a lower wiring plate having a first circuit pattern, wherein the first circuit pattern comprises plural lower contacts; and
an upper wiring plate having a second circuit pattern, wherein the second circuit pattern comprises plural upper contacts corresponding to the plural lower contacts, wherein each of the upper contacts and the corresponding lower contact are separated from each other by a spacing distance, and each of the upper contacts and the corresponding lower contact are collaboratively defined as the corresponding membrane switch,
wherein the sensing antenna circuit is arranged between the upper wiring plate and the lower wiring plate, or the sensing antenna circuit is disposed on a top surface of the lower wiring plate or a bottom surface of the upper wiring plate.

19. The luminous keyboard according to claim 18, wherein the membrane wiring board further comprises an intermediate plate, wherein the intermediate plate is arranged between the upper wiring plate and the lower wiring plate, so that each of the upper contacts and the corresponding lower contact are separated from each other by the spacing distance, wherein the intermediate plate comprises plural perforations corresponding to the plural upper contacts and the plural upper contacts, respectively, wherein the sensing antenna circuit is disposed on the top surface of the lower wiring plate, a bottom surface of the lower wiring plate, a top surface of the intermediate plate, a bottom surface of the intermediate plate, a top surface of the upper wiring plate or the bottom surface of the upper wiring plate.

20. The luminous keyboard according to claim 19, wherein at least one of the lower wiring plate, the intermediate plate and the upper wiring plate is made of a light-guiding material.

21. The luminous keyboard according to claim 17, further comprising a metallic supporting plate for connecting the plural keys, wherein the sensing antenna circuit comprises at least one sensing region, and the metallic supporting plate comprises at least one supporting plate aperture corresponding to the at least one sensing region.

22. The luminous keyboard according to claim 21, wherein each of the plural keys comprises:
a keycap exposed outside the luminous keyboard; and
a connecting element arranged between the metallic supporting plate and the keycap for connecting the metallic supporting plate and the keycap, and allowing the keycap to be moved upwardly or downwardly relative to the metallic supporting plate.

23. The luminous keyboard according to claim 22, wherein each of the plural keys comprises an elastic element, the elastic element is arranged between the keycap and the metallic supporting plate, and the elastic element has a sustaining part, wherein the connecting element is a scissors-type connecting element, wherein when the keycap is depressed, the elastic element is compressed, so that the corresponding membrane switch is pushed by the sustaining part, wherein when the keycap is not depressed, the keycap is returned to an original position in response to an elastic force provided by the elastic element.

24. The luminous keyboard according to claim 15, wherein the proximity sensor is an optical proximity sensor, a specified key of the plural keys corresponding to the sensing unit has a sensing ray outputting region.

25. The luminous keyboard according to claim 24, wherein the membrane wiring board comprises:
a lower wiring plate having a first circuit pattern, wherein the first circuit pattern comprises plural lower contacts; and
an upper wiring plate having a second circuit pattern, wherein the second circuit pattern comprises plural upper contacts corresponding to the plural lower contacts, wherein each of the upper contacts and the corresponding lower contact are separated from each other by a spacing distance, and each of the upper contacts and the corresponding lower contact are collaboratively defined as the corresponding membrane switch,
wherein the optical proximity sensor is disposed on a top surface of the lower wiring plate.

26. The luminous keyboard according to claim 25, wherein at least one of the lower wiring plate and the upper wiring plate is made of a light-guiding material.

27. The luminous keyboard according to claim 15, further comprising a keyboard circuit board, wherein the keyboard circuit board is in communication with a computer system, wherein the keyboard circuit board is connected with the membrane wiring board and the proximity sensor through a single flat cable.
